(19) United States
(12) Patent Application Publication
(10) Pub. No.: US 2007/0295133 A1
(43) Pub. Date: Dec. 27, 2007

(54) Ball Screw with an Engaging Type Circulation Cassette

(76) Inventor: Xin-he Chen, Taichung Industrial Park (TW)

Correspondence Address: Dr. BANGER SHIA, 102 Lindencrest Ct, Sugar Land, TX, 77479-5201, US

(21) Appl. No.: 11/422,567

(22) Filed: Jun. 6, 2006

(51) Int. Cl. F16H 1/24; F16H 55/02

(52) U.S. Cl. 74/424.87

(57) ABSTRACT

A ball screw with an engaging type circulation cassette comprises a nut, a screw shaft and a circulation cassette. The nut and the circulation cassette are defined with a locking groove and a protruding block respectively, and an elastic connecting portion is defined on the circulation cassette for connecting with the engaging groove or the engaging block. Thereby this invention solves the conventional problem of fixing the circulation cassette to the nut only by using the locking element, and the elastic connecting portion of the circulation cassette can increase the convenience for assembling. Furthermore, the circulation path of the circulation cassette is of close type, which can prevent the ball from impacting the nut, so as to reduce the generation of noise.

### BACKGROUND OF THE INVENTION

1. Field of the Invention

The present invention relates to a ball screw, and more particularly to a ball screw with an engaging type circulation cassette.

2. Description of the Prior Art

Nowadays, ball screw is used more and more widely in modern industries. As a linear transmission means, the ball screw not only has high precision but also has the advantages of low frictional loss, high energy conversion ratio, low noise and high rigidity. Hence, it is self-evident that the ball screw is very important to various industrial mechanisms. In order for the balls between the screw shaft and the nut to circulate smoothly and for relieving the stress therebetween, the nut is usually provided at both ends thereof with two circulation cassettes for cooperating with the threads of the screw shaft and the balls. And the circulation cassette is a key structure for enabling the balls circulation from the screw shaft and the nut. Therefore, how to develop an improved and competitive circulation cassette is the common goal that the manufactures are striving for.

The existing ball screw is essentially comprised of nut, screw shaft and balls. And the commonly seen ball circulation manners include: inner circulation, outer circulation and cassette circulation. The resistance and friction of the inner circulation is relatively small since each circle forms a circulation. However, it must use the outer circulation ball screw if want to bear a relatively large load. As for the outer circulation, it should arrange a circulation tube on the outer periphery of the nut for guiding the circulation of the balls, and as a result, the nut is definitely increased. In order to reduce the size of the nut and increase the load capacity thereof, it must take the cassette circulation.

Referring to FIG. 1, a conventional cassette circulation type ball screw is shown, which is disclosed by U.S. Pat. No. 4,357,838, wherein the circulation cassette 12 is fixed in an installing cavity 111 at the end of the helical groove of the nut 11 by a screw 10, and an open circulation path 121 is defined in the circulation cassette 12 for guiding the balls' circulation. This conventional product has the following disadvantages:

First, the assembly process is too complicated since the circulation cassette 12 should be installed in the installing cavity 111, after that, the screw 10 is inserted through the locking hole 112 of the nut 11, and finally the circulation cassette 12 is fixed on the nut 11 by the screw 10.

Second, the circulation path 121 in the circulation cassette 12 is open type, during circulation, the balls will have a direct contact with the nut 11, and thus noise will be produced.

To solve the aforementioned problem, another circulation cassette type ball screw appeared on the market, as shown in FIG. 2, which is disclosed by U.S. Pat. No. 5,664,459, wherein the circulation cassette 14 is fixed on the nut 15 by a C ring 13. As for this assembling process of this ball screw, the circulation cassette 14 should be installed in the installing recess 151 of the nut 15 initially, after that, the C ring 13 is engaged in the engaging groove 152 of the nut 15, so that the circulation cassette 14 is fixed. And this design still has the following disadvantages:

First, the assembly is too complicated, and it should add the C ring 13.

Second, the circulation path 141 in the circulation cassette 14 is open type, during circulation, the balls will have a direct contact with the nut 15, and thus noise will be produced.

The present invention has arisen to mitigate and/or obviate the afore-described disadvantages.

### SUMMARY OF THE INVENTION

The primary objective of the present invention is to provide a circulation cassette type ball screw that is easily assembled and only has a small number of components.

To achieve this objective, the nut and the circulation cassette are defined with a plurality of locking grooves and protruding blocks, respectively. The circulation cassette is also provided with elastic connecting portions for connecting with the locking grooves or the protruding blocks. By such arrangements, the cassette can be positioned on the nut directly without the use of any other locking elements. Therefore, the cost is decreased along with the number of the components, and the elastic connecting portion of the circulation cassette facilitates the assembly.

The secondary objective of the present invention is to provide a low noise ball screw with circulation cassette.

To achieve this objective, the circulation path is of close type, a laminal guiding piece is arranged between the balls and the nut. Therefore, the balls entering the circulation cassette will not impact the metal nut, and the noise will be reduced.

The present invention will be more clear from the following description when viewed together with the accompanying drawings, which show, for purpose of illustrations only, the preferred embodiment in accordance with the present invention.

### BRIEF DESCRIPTION OF THE DRAWINGS

FIG. 1 shows a conventional cassette circulation type ball screw;

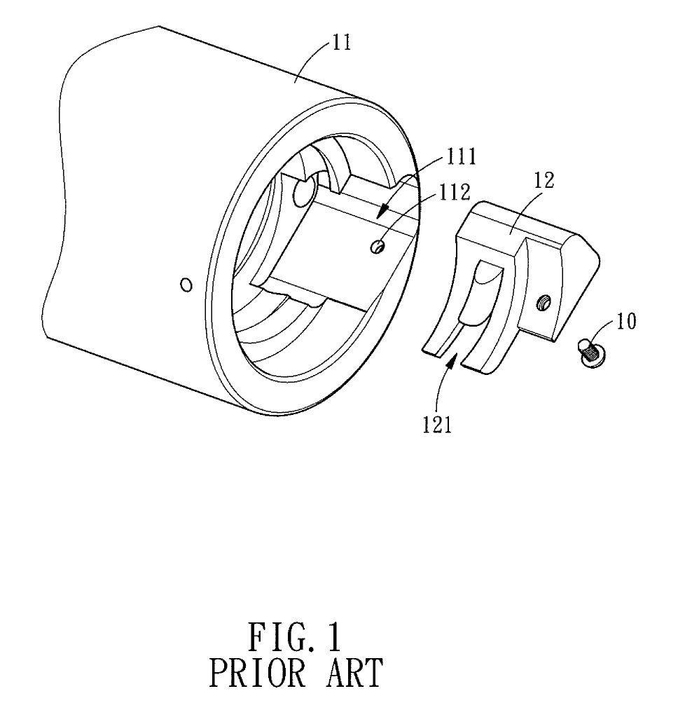

FIG. 2 shows another conventional cassette circulation type ball screw;

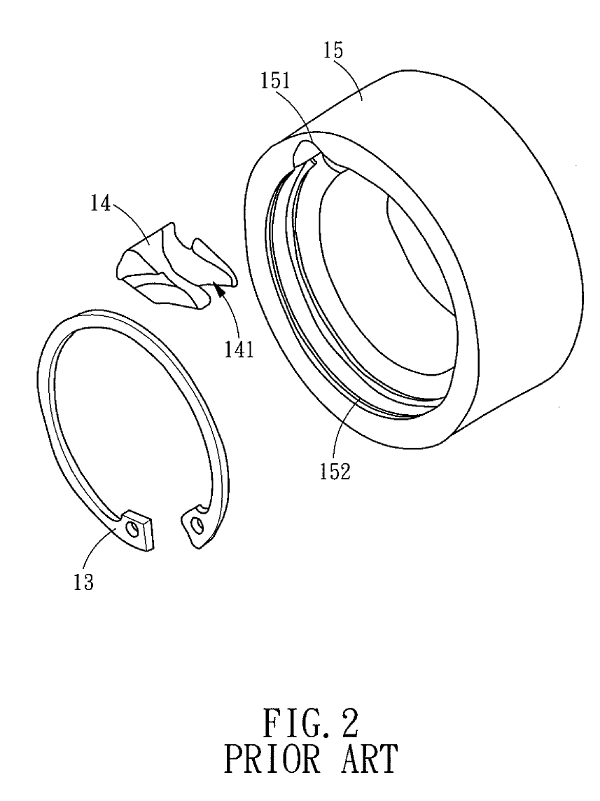

FIG. 3 is a perspective view of a circulation cassette in accordance with the present invention;

FIG. 4 is an exploded view of a cassette circulation type ball screw in accordance with an embodiment of the present invention (the screw shaft is not shown);

FIG. 5 is an assembly view of a cassette circulation type ball screw in accordance with an embodiment of the present invention (the screw shaft is not shown);

FIG. 6 is an exploded view of a cassette circulation type ball screw in accordance with another embodiment of the present invention (the screw shaft is not shown); and

FIG. 7 is an assembly view of a cassette circulation type ball screw in accordance with another embodiment of the present invention (the screw shaft is not shown).

### DETAILED DESCRIPTION OF THE PREFERRED EMBODIMENTS

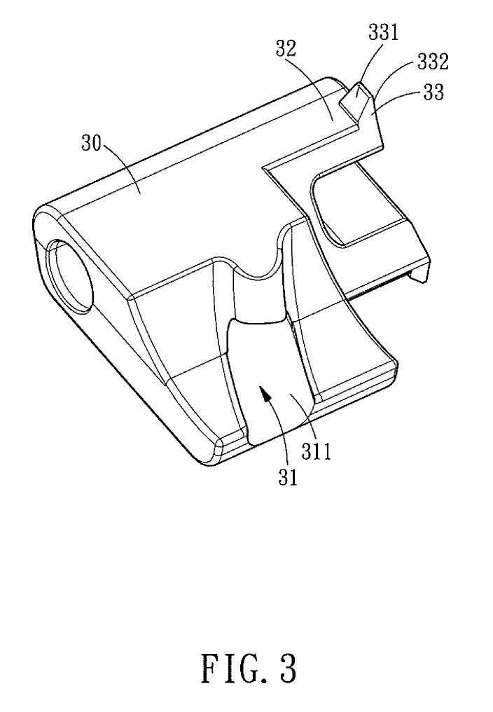

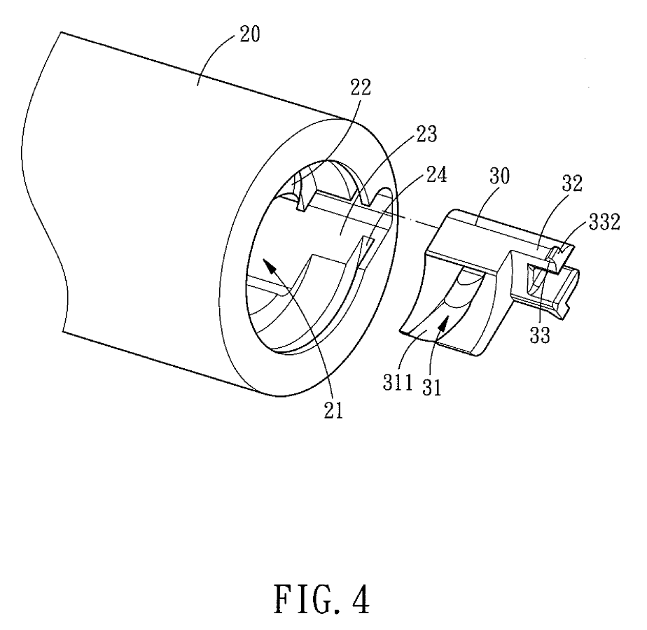

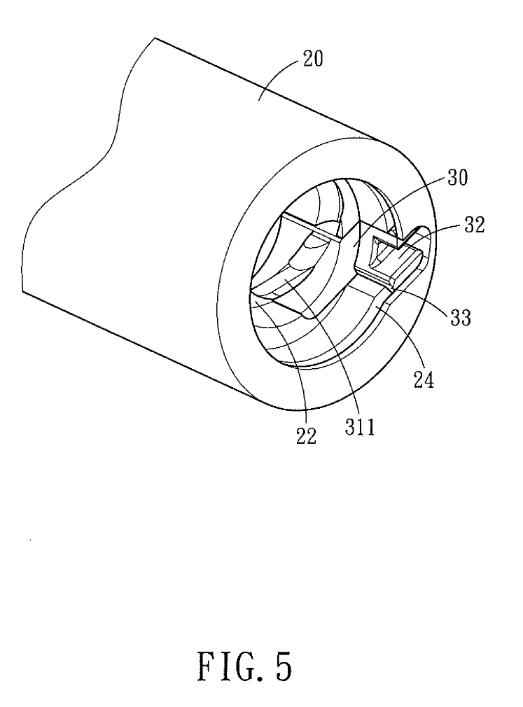

Referring to FIGS. 3-5, a ball screw with an engaging type circulation cassette in accordance with the present invention comprises: a nut 20, a screw shaft (not shown), a circulation cassette 30, and a plurality of balls (not shown).

The nut 20 is defined with an axial through hole 21, lateral circulation holes (not shown), and a helical groove 22. A recess 23 is formed in the end surface of the nut 20 and is located correspondingly to the helical groove 22 and the circulation holes, and an annular locking groove 24 is formed outside the recess 23.

The screw shaft is inserted in the through hole 21 of the nut 20, and the screw shaft cooperates with the helical groove 22 of the nut 20 to define a space for reception of the plurality of balls.

The circulation cassette 30 is received in the recess 23 of the nut 20 and is defined with a close type circulation path 31. A laminal guiding piece 311 is arranged in the circulation path 31 for abutting against the helical groove 22 of the nut 20, and the circulation path 31 is connected to the circulation holes. A plurality of protruding elastic connecting portions 32 is formed on the circulation cassette 30, and a plurality of protruding blocks 33 is integrally connected to the end of the connecting portions 32 and is shaped for mating with the locking groove 24. A slant surface 331 is formed on each of the protruding blocks 33 and is located in the direction of the locking groove 24, and an abutting surface 332 is formed on each of the protruding blocks 33 and located opposite the slant surface 332.

The protruding block 33 of the circulation cassette 30 and the locking groove 24 of the nut 20 can be interchanged in position according to needs. The locking groove 24 can also be formed in the elastic connecting portions 32 of the circulation cassette 30.

In assembly, the screw shaft is inserted in the nut 20 initially, forming a ball receiving space with respect to the helical groove 22 of the nut 20. At this moment, the circulation cassette 30 can be placed directly into the recess 23 of the nut 20 and is positioned therein via the end surface of the nut 20. At this moment, with the aid of the slant surface 331 and the elastic connecting portions 32 will be deformed to enable the protruding blocks 33 of the circulation cassette 30 to enter the locking groove 24 and to be locked therein. Besides, the protruding blocks 33 of the circulation cassette 30 is engaged in the locking groove 24 since it is restricted by the abutting surface 332, thus positioning the circulation cassette 30 on the end surface of the nut 20.

By such arrangements, with the help of the slant surface 331 and the deformation of the elastic connecting portion 32, the protruding blocks 33 of the circulation cassette 30 can be directly engaged and positioned in the locking groove 24 of the nut 20 very quickly, without needing any locking elements.

On the other hand, the circulation cassette 30 is defined with the close type circulation path 31, the laminal guiding piece 311 is arranged in the circulation path 31 for abutting against the helical groove 22 of the nut 20, and the circulation path 31 is connected to the circulation holes. And the guiding piece 311 is located between the balls and the nut 20. Therefore, the balls entering the circulation cassette will not impact the metal nut, and the noise will be reduced.

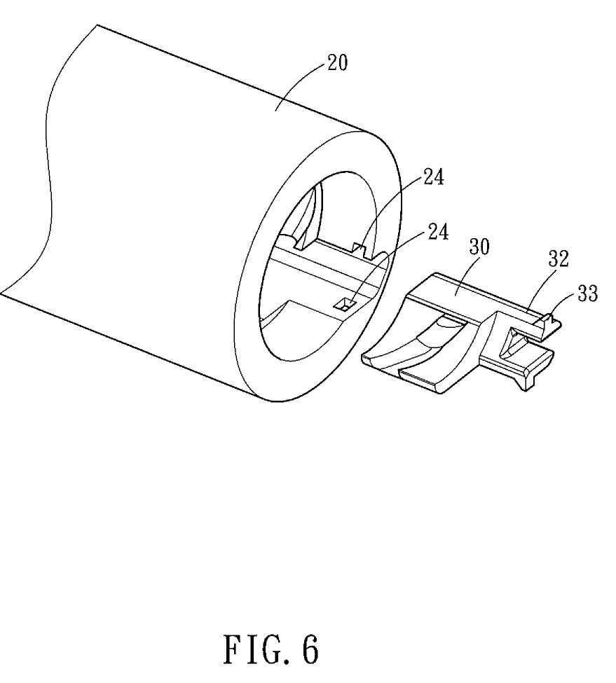

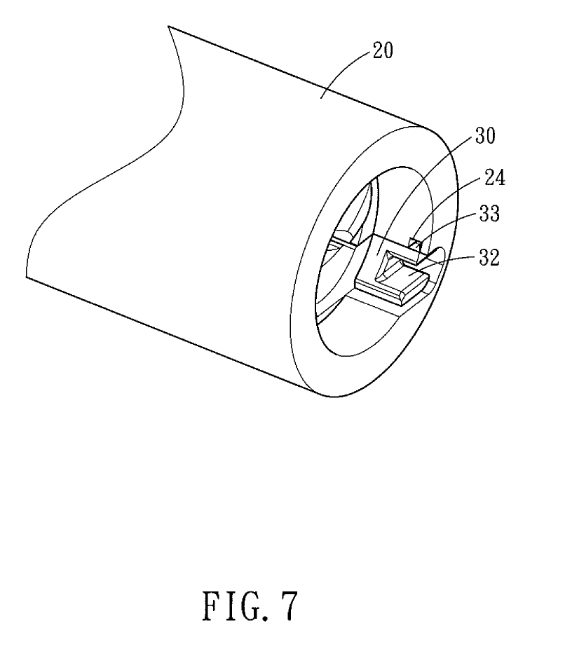

Referring to FIGS. 6 and 7, another embodiment of the locking grooves is shown, wherein the locking grooves 24 of the nut 20 are not annular and are shaped for mating with the protruding blocks 33 of the elastic connecting portion 32.

While we have shown and described various embodiments in accordance with the present invention, it is clear to those skilled in the art that further embodiments may be made without departing from the scope of the present invention.

What is claimed is:

1. A ball screw with an engaging type circulation cassette comprising a nut having circulation holes, a screw shaft inserted in the nut, and a circulation cassette, characterized in that:
the circulation cassette is defined with elastic connecting portions, at least one protruding block is formed on the elastic connecting portion for engaging with at least one locking groove in the nut.

2. The ball screw with an engaging type circulation cassette as claimed in claim 1, wherein the circulation cassette is defined with a close type circulation-path, a laminal guiding piece is arranged in the circulation path for abutting against the helical groove of the nut, and the circulation path is connected to the circulation holes.

3. The ball screw with an engaging type circulation cassette as claimed in claim 1, wherein:
a recess is formed in an end surface of the nut for abutting against a helical groove and circulation holes of the nut, a locking groove is formed in the recess; and
the circulation cassette is engaged in the recess of the nut, the elastic connecting portions are protruded out of the circulation cassette, a slant surface is formed on the protruding block and is located in the direction of the locking groove, and an abutting surface is formed on the protruding block and located opposite the slant surface.

4. The ball screw with an engaging type circulation cassette as claimed in claim 2, wherein:
a recess is formed in an end surface of the nut and is located correspondingly to a helical groove and circulation holes of the nut, a locking groove is formed in the recess; and
the circulation cassette is engaged in the recess of the nut, a plurality of protruding elastic connecting portions is formed on the circulation cassette, a slant surface is formed on the protruding block and is located in the direction of the locking groove, and an abutting surface is formed on the protruding block and located opposite the slant surface.

5. The ball screw with an engaging type circulation cassette as claimed in claim 3, wherein the locking groove is annular and is located outside the recess.

6. The ball screw with an engaging type circulation cassette as claimed in claim 4, wherein the locking groove is annular and is located outside the recess.

7. The ball screw with an engaging type circulation cassette as claimed in claim 1, wherein:
a recess is formed in an end surface of the nut and is located correspondingly to the helical groove and the circulation holes, the protruding block is formed outside the recess, a slant surface is formed on the protruding block, and an abutting surface is formed on the protruding block and located opposite the slant surface; and
the circulation cassette is engaged in the recess of the nut, a plurality of protruding elastic connecting portions is formed on the circulation cassette, the locking groove is formed in the elastic connecting portion and is shaped for mating the protruding block, the protruding block is engaged in the locking groove.

8. The ball screw with an engaging type circulation cassette as claimed in claim 2, wherein:
a recess is formed in an end surface of the nut and is located correspondingly to the helical groove and the circulation holes, the protruding block is formed outside the recess, a slant surface is formed on the protruding block, and an abutting surface is formed on the protruding block and located opposite the slant surface; and
the circulation cassette is engaged in the recess of the nut, a plurality of protruding elastic connecting portions is formed on the circulation cassette, the locking groove is formed in the elastic connecting portion and is shaped for mating the protruding block, the protruding block is engaged in the locking groove.
